(19) United States
(12) Patent Application Publication
(10) Pub. No.: US 2007/0021887 A1
(43) Pub. Date: Jan. 25, 2007

(54) Method and system for controlling a yawing moment actuator in a motor vehicle

(75) Inventors: Rolf Hofmann, Weil Der Stadt (DE); Hai Tran Xuan, Korntal-Muenchingen (DE)

Correspondence Address: CROWELL & MORING LLP;INTELLECTUAL PROPERTY GROUP, P.O. BOX 14300, WASHINGTON, DC, 20044-4300, US

(73) Assignee: Dr. Ing. h.c.F. Porsche Aktiengesellschaft, Stuttgart (DE)

(21) Appl. No.: 11/489,513

(22) Filed: Jul. 20, 2006

(30) Foreign Application Priority Data
Jul. 21, 2005 (DE) 10 2005 033 995.6

(51) Int. Cl. G06F 7/00

(52) U.S. Cl. 701/40

(57) ABSTRACT

A system and a method for controlling a yawing moment actuator (8) in a motor vehicle, having the process steps of detecting the current steer angle of the motor vehicle; determining the current coefficient of friction between the tire of the motor vehicle and the road; detecting the current driving speed of the motor vehicle; defining a desired curve as a function of the current steer angle, of the current coefficient of friction and of the current driving speed, which represents a connection between the steer angle and a desired lateral acceleration (a_{y desired}) at a predetermined coefficient of friction, and adjusting the yawing moment of the yawing moment actuator (8) such that the resulting current total lateral acceleration of the motor vehicle is regulated to the desired lateral acceleration (a_{y desired}) assigned to the current steer angle according to the defined desired curve.

### BACKGROUND AND SUMMARY OF THE INVENTION

Priority is claimed based on German Application No. DE 102005033995 filed, Jul. 21, 2005, which is expressly incorporated herein by reference.

The present invention relates to a method and a system for controlling a yawing moment actuator in a motor vehicle.

Systems for improving the driving dynamics of a motor vehicle play a growing role in the development of vehicles for ensuring an increasing safety for the vehicle occupants.

In addition to the passive and active safety systems, such as air bags, impact protection and seat belt tighteners, increasingly active control systems for the driving dynamics with their growing possibilities are becoming more and more important.

In this case, a control system is desirable which rapidly detects the momentary driving situation and is capable of immediately actively intervening in a possibly critical situation and of supplying the driver with a corresponding signal for a manual change of the driving situation. The first steps of an active vehicle control were already made on the basis of the ABS, the electronic stability program ESP or a traction distribution system.

When traveling through a curve with a predetermined cornering radius, a lateral acceleration occurs which is a function of the cornering radius and of the vehicle speed. In order to keep the vehicle on the desired cornering radius, the motor vehicle driver sets the required steer angle by means of the steering operation. In the case of certain road conditions, the lateral force available at the front axle between the tire and the road is not sufficient for being able to travel the endeavored cornering radius at the desired speed, and the vehicle front axle slips to the outside of the curve.

Yawing movement actuators are known which make it possible to act upon the vehicle with an additional yawing moment by generating an asymmetrical driving torque at the driven vehicle axles. As a result, the driving dynamics of the vehicle can be positively influenced in that, according to the demand and as a function of the situation, an agilizing or stabilizing yawing moment is introduced into the vehicle by way of the longitudinal forces of the tires.

The known algorithms for controlling such driving-dynamics-related systems have the disadvantage that they only slightly influence the vehicle handling in the quasistatic range or, as an alternative, result in a vehicle handling during which the limit range of the vehicle cannot be detected sufficiently early by the driver, resulting in a nonharmonic vehicle handling, so that these systems become effective only during dynamic driving maneuvers. The potential of this system is therefore not completely utilized.

It is therefore an object of the invention to provide an improved method and a simple cost-effective system for controlling a yawing moment actuator in a motor vehicle by which the physically possibilities of such a yawing moment actuator can be further utilized.

The concept on which the present invention is based consists of detecting the current steer angle and the driving speed of the motor vehicle when the motor vehicle is cornering; of determining the current coefficient of friction between the tires of the motor vehicle and the road; of defining a desired curve as a function of the determined current coefficient of friction, of the steer angle and of the driving speed; and of adjusting the yawing moment of the yawing moment actuator such that the resulting current total lateral acceleration of the motor vehicle is controlled to the desired lateral acceleration assigned to the determined current steer angle according to the defined desired curve.

In comparison to the known methods, the present invention therefore has the advantage that the yawing moment of the yawing moment actuator can be adjusted such that the total lateral acceleration as a function of the current road characteristics is adapted to a desired characteristic curve first assigned to these road characteristics. This desired characteristic curve is selected such that, on the one hand, it expands the limit range of the maximal lateral vehicle acceleration to the value reachable by means of the yawing moment generator and that simultaneously a harmonic reproducible course of the roll steer effect of the vehicle is advantageously maintained.

According to a further development, the current steer angle is detected by means of a steer angle sensor. As a rule, such steer angle sensors are present in already existing driving-dynamics-related systems of the vehicle, so that they can be used in an easy and cost-effective manner.

According to another embodiment, the current coefficient of friction between the tire of the vehicle and the road is determined by using the inverse Pacejka tire model. This represents a permissible algorithm for determining the current coefficient of friction. Preferably, the current longitudinal tire slip and lateral tire slip as well as the current longitudinal tire force and lateral tire force are determined, by using the Pacejka tire model, and the ratio between the tire slip and the tire force are analyzed and compared with previously known tire characteristics. For determining the current lateral tire slip, for example, the current tire slip angle of the motor vehicle is detected and converted to the assigned tire slip speed and to the tire slip value by dividing by a reference speed. For example, for determining the current coefficient of friction, additional values, such as the longitudinal acceleration, the lateral acceleration and/or the wheel load of the motor vehicle can also be taken into account. As a result, a reliable method of determining the current coefficient of friction is ensured whose precision increases as the tire slip increases, whereby it becomes very suitable for a use in the system introduced here.

According to another further development, the current cornering curvature is determined by detecting and evaluating the current lateral acceleration and the current driving speed of the motor vehicle and also taken into account for defining a suitable desired curve. The sensors required for this purpose are again, as a rule, already present in the existing systems of the motor vehicle, so that the signals of these sensors can be used. As a result, a high-expenditure cost-effective modification of the motor vehicle is advantageously avoided.

Desired curves are preferably determined first and are filed as desired characteristic curves in a suitable memory device of the control device, which desired characteristic curves represent the desired connection between the steer angle and the desired lateral acceleration at the given coefficient of friction. As a result, preferred desired characteristic curves can be assigned to each vehicle model and each road characteristic according to predetermined safety provisions, which desired characteristic curves can be achieved by the corresponding adjustment of the yawing moment of the yawing moment actuator.

According to a further preferred embodiment, an additional yawing moment is superimposed on the yawing moment of the yawing moment actuator to be adjusted, which additional yawing moment is derived from the deviation between the yaw rate desired by the driver of the motor vehicle and the current yaw rate. The current yaw rate of the motor vehicle is preferably determined by means of a yaw rate sensor device of a driving-dynamics-related system already existing in the vehicle and the yaw rate desired by the driver is determined by detecting the current steer angle as well as the vehicle speed and/or the lateral acceleration of the motor vehicle. A certain anticipatory control can therefore be achieved which increases the dynamics of the system. This results in an improved vehicle handling, particularly, in the case of highly dynamic driving maneuvers, such as steer angle discontinuities or lane changes. In addition, the sensors of existing vehicle systems can advantageously again be used, so that a disadvantageous retrofitting is eliminated.

In the following, the invention will be explained in detail by means of embodiments with reference to the attached figures.

### BRIEF DESCRIPTION OF THE DRAWINGS

FIG. 1 is a schematic block diagram of a system for controlling a yawing moment actuator in a motor vehicle according to a preferred embodiment of the present invention;

FIG. 2 is a schematic representation of the process steps of a method of controlling a yawing moment actuator in a motor vehicle according to a preferred embodiment of the present invention;

FIG. 3a is a graphic representation of steer angle demand curves/desired curves as a function of the coefficient of friction;

FIG. 3b is a graphic representation of steer angle demand curves/desired curves as a function of the cornering radius;

FIG. 3c is a graphic representation of a steer angle demand curve/desired curve of a motor vehicle with and without a controlling of a yawing moment actuator according to the invention; and

FIG. 4 is a schematic representation of a yawing moment actuator according to a preferred embodiment of the present invention.

In the figures, the same reference numbers indicate identical components or components having the same function, unless indicated otherwise.

### DETAILED DESCRIPTION OF THE DRAWINGS

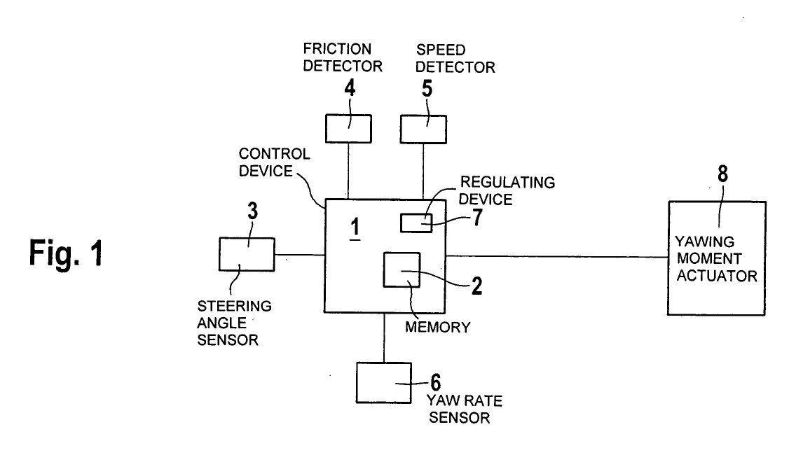

FIG. 1 is a schematic block diagram of a system for controlling a yawing moment actuator 8 according to a preferred embodiment of the present invention. The system essentially consists of a control device 1 in which a suitable memory device 2 is contained or is optionally connected with the latter. First, desired curves, which represent a connection between the steer angle and a desired lateral acceleration (a_{ydesired}) at a predetermined coefficient of friction, are stored in the memory device 2, taking into account different coefficients of friction, driving speed or different cornering curvatures.

The control device 1 is connected with many different sensors or detection devices for receiving predetermined input quantities. According to FIG. 1, the control device 1 is connected only as an example with a steer angle detection device 3, preferably a steer angle sensor 3, a coefficient-of-friction detection device 4, a driving speed detection device 5 as well as a yaw rate sensor device 6. It is obvious to a person skilled in the art that the control device 1 may be connected with additional sensors or detection devices, which are not shown, for receiving additional usable signals, such as a cornering curvature detection device. Systems, particularly driving-dynamics-related systems, with sensor devices or detection devices for detecting diverse current vehicle characteristics already exist in a modern motor vehicle. As a rule, detection devices for the detection of the current steer angle, of the current longitudinal tire slip, of the current lateral tire slip, of the current longitudinal tire force, of the current lateral tire force, of the current longitudinal acceleration, of the current wheel load, of the current lateral acceleration, of the current driving speed as well as of the current yaw rate are present in the motor vehicle. Thus, the control device can advantageously use the signals of these components already existing in the motor vehicle, so that a high-expenditure modification is eliminated.

From certain input quantities, as described in greater detail below, the control device 1 computes certain output quantities which are required for the adjustment of the yawing moment of the yawing moment actuator 8 by way of an adjusting device 7 which is constructed, for example, as a regulating device integrated in the control device 1. For this purpose, in addition to the first determined desired curves, certain algorithms can be filed in the memory device 2, by means of which algorithms the control device 1 computes the required quantities as well as the suitable regulating values.

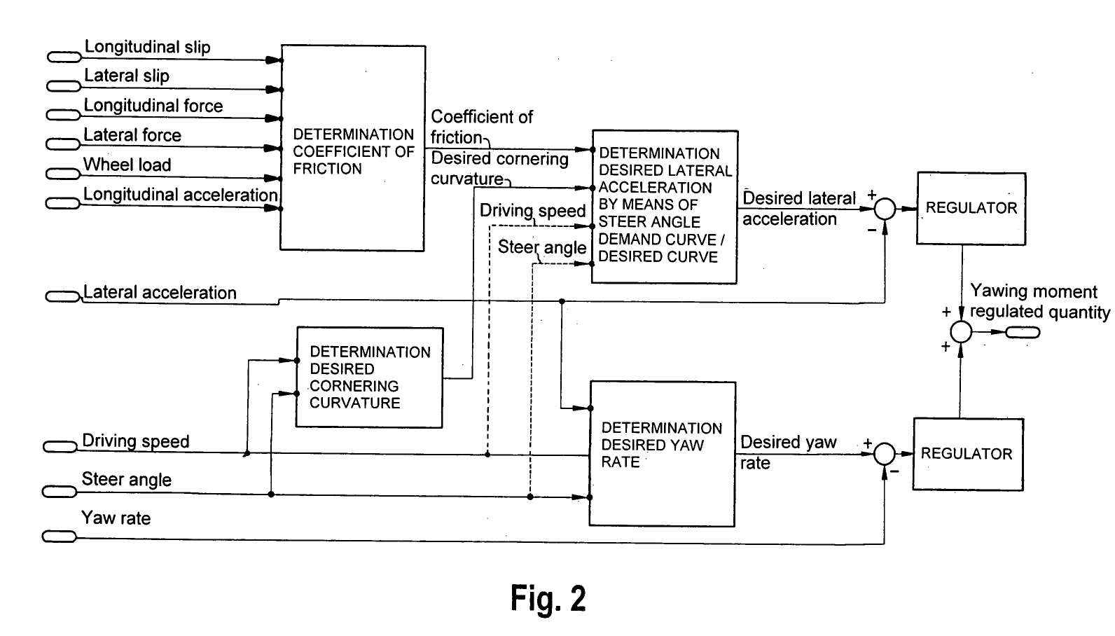

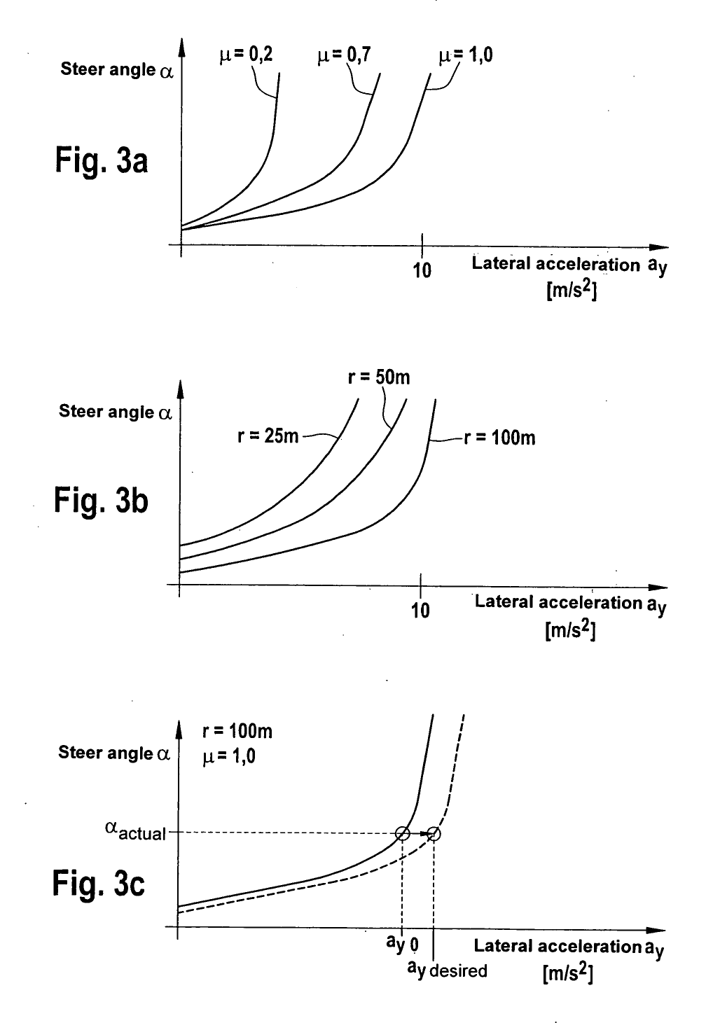

In the following, a method of controlling the yawing moment actuator 8 is explained in detail with reference to FIGS. 2 and 3 according to a preferred embodiment of the present invention.

As illustrated in FIG. 2, the current steer angle when cornering is detected by, for example, a steer angle sensor and is transmitted to the control device. Subsequently, one of the desired curves, which curves are a function of the coefficient of friction and/or of the driving speed and/or of the cornering curvature and are filed in the memory device, is assigned to this detected current steer angle, for determining the desired lateral acceleration assigned to this current steer angle. For defining the desired curve assigned to the current steer angle, the control device determines the current coefficient of friction between the vehicle tire and the road as well as the current driving speed and, as required, the current cornering curvature from the predetermined input quantities, as will be described in greater detail in the following.

For determining the current coefficient of friction, as schematically illustrated in FIG. 2, preferably the ratio between the current tire slip and the current tire force is determined and compared with the previously known tire characteristics. Such previously known tire characteristics can again be first filed in the memory device 2 of FIG. 1. For example, for determining the current coefficient of friction, the inverse Pacejka tire model is used which, particularly in the case of a critical major tire slip and thus in the case of the important critical driving situations, represents a reliable method of determining the current coefficient of friction. This method of determining the current coefficient of friction is known per se, so that only the essential features will be briefly discussed in the following.

The current tire slip required for the Pacejka tire model is composed of the current longitudinal tire slip and the current lateral tire slip at the tire during the driving operation. For the determination of the current longitudinal tire slip, for example, the rotational speeds of the driving axle and of the dead axle used as the reference can be compared with one another and deviations of the angle of rotation can be determined. In a manner known per se, the longitudinal slip can be determined by way of the current driving speed and the speed of the corresponding tire.

According to the present embodiment, the current lateral tire slip is preferably determined by way of the tire slip angle.

In order to facilitate the applicability of the method according to the invention in the control device with a limited memory and computing capacity, the mutually superimposed vectorial quantities are preferably converted to scalar quantities. The slip of the tires is measured in a manner known per se, in which case the measured tire slip angle is converted to a slip speed by means of the control device and by the division by an assigned reference speed is converted to the present lateral tire slip. The size of the current lateral tire slip is measured analogously to the current longitudinal tire slip, preferably in percent, so that the two quantities—longitudinal tire slip and lateral tire slip—which can be detected by measuring in the vehicle, are advantageously made available in the same unit of measurement, which can be vectorially added in a simple manner requiring little computing capacity.

In addition, the current longitudinal tire force and the current lateral tire force are required for a use of the inverse Pacejka tire model, as explained above. For example, the signals of assigned longitudinal acceleration and lateral acceleration sensors can advantageously be used, in which case the control device converts the received signals of these acceleration sensors to the corresponding current longitudinal and lateral tire forces. The current longitudinal tire force and lateral tire force are preferably also vectorially added such that two vectors are obtained which point in the same direction. The amounts of these vectors are entered into the inverse Pacejka tire model for determining the current coefficient of friction, so that the current coefficient of friction between the tire and the road is reliably determined.

Advantageously, the current longitudinal acceleration, the current lateral acceleration and/or the current wheel load can also be taken into account when determining the current coefficient of friction by means of the Pacejka tire model. The more current input quantities are available for determining the current coefficient of friction, the more precise and more reliable its determination.

As briefly explained above, in addition to the current coefficient of friction, the current driving speed or the current cornering curvature is also required for defining the desired curve assigned to the detected current steer angle. For example, for the determination of the momentarily driven cornering curvature, the signals of the current steer angle and of the current driving speed are used, as schematically illustrated in FIG. 2. For detecting the current driving speed, for example, the signals of the rotational wheel speed sensors can be analyzed.

Accordingly, as a function of the determined input quantities—current coefficient of friction, current driving speed and, as required, desired cornering curvature—, the control device assigns a predetermined desired curve to the current steer angle, from which the a desired lateral acceleration is obtained.

FIG. 3a illustrates three steer angle demand curves, used as examples; that is, the steer angle α to lateral acceleration ratio a_{y}. The steer angle demand curves shown as examples are assigned to different coefficients of friction; for example, the coefficient of friction φ=0.2 is assigned to a snow-covered road; the coefficient of friction φ=0.7 is assigned to a moist road; and the coefficient of friction φ=1 is assigned to a dry road. As illustrated in FIG. 3a, as the coefficient of friction increases, a greater lateral acceleration a_{y} can be reached with a determined steer angle α.

FIG. 3b illustrates three steer angle demand curves used as examples, which are each assigned to a different cornering radius r of the traveled curve. As illustrated in FIG. 3b, as the cornering radius r increases, a greater lateral acceleration a_{y} can be reached with a predetermined steer angle α.

FIG. 3c illustrates two steer angle demand curves; the curve illustrated by a solid line being assigned to a previous motor vehicle not controlled according to the invention, and the curve represented by a broken line being assigned to a motor vehicle whose yawing moment actuator is controlled according to the invention. As explained above, based on the determined current steer angle, the current coefficient of friction and the determined driving speed and/or the determined current cornering curvature, a desired curve is defined by the control device 1 which corresponds, for example, to the steer angle demand curve illustrated in FIG. 3c by a broken line. Here, it was assumed only as an example that the cornering radius r of the traveled curve 100 and the current coefficient of friction φ between the tire and the road corresponds to 1.0. The desired curves first filed in the memory device may be determined, for example, by driving tests carried out beforehand, according to certain criteria.

As a result, a maximal lateral acceleration is preferably first assigned to each coefficient of friction and each cornering curvature and is filed in the memory device. That means that, when the coefficient of friction and the cornering curvature are known, the maximal lateral acceleration can be forecast without an adjustment of the yawing moment at the yawing moment actuator, and, as a result, the lateral acceleration increased by a corresponding yawing moment can also be forecast. The steer angle to lateral acceleration or possible maximal lateral acceleration ratio can thereby be advantageously modified, as explained in the following.

As illustrated in FIG. 3c, a reference lateral acceleration a_{y0} of the passive vehicle without a control of the yawing moment is assigned to the current steer angle α_{actual} of the not controlled vehicle. However, in the present embodiment, this reference lateral acceleration a_{y0} does not correspond to the desired lateral acceleration a_{y desired} defined by the desired curve and assigned to the current steer angle α_{actual}. The yawing moment of the yawing moment actuator is therefore adjusted by the control device by means of the regulating device such that the resulting current total lateral acceleration is regulated to the desired lateral acceleration a_{y desired} defined by the desired curve. The desired curve is preferably rescaled in the direction of a higher total lateral acceleration, as illustrated in FIG. 3c. By admitting additional yawing moment to the yawing moment actuator, as a result of the current steer angle α_{actual}, a greater total lateral acceleration can be reached which preferably corresponds to the desired lateral acceleration a_{y desired} or at least approaches it on the basis of a slight deviation. As a result, by means of the adjusting of the yawing moment at the yawing moment actuator, the limit range can be expanded such that, on the whole, higher lateral accelerations are reached. This increases the driving potential and thereby also the driving safety.

Preferably by addition, another yawing moment is superimposed on the yawing moment of the yawing moment actuator determined according to the above explanations, which additional yawing moment is derived from the deviation between the yaw rate desired by the motor vehicle driver and the current yaw rate. Particularly during highly dynamic driving maneuvers, the motor vehicle driver is thereby actively aided because the time span between the steering operation and the occurring yaw rate is actively compensated.

The yaw rate desired by the driver is derived from the steering wheel angle and driving speed or steering wheel angle and lateral acceleration quantities measured in the vehicle from the desired yaw rate. Simultaneously, the current yaw rate is measured, for example, by means of a yaw rate sensor device which is generally contained in the existing driving-dynamics-related system. A yawing moment, which is derived from desired-actual deviation of the vehicle yaw rate change, results in a considerably improved vehicle handling, particularly during highly dynamic driving maneuvers, as, for example, during a steer angle discontinuity, or a driving lane change. Thus, as a result of this superimposition of yawing moments, an anticipatory control can be achieved which further increases the dynamics of the control according to the invention.

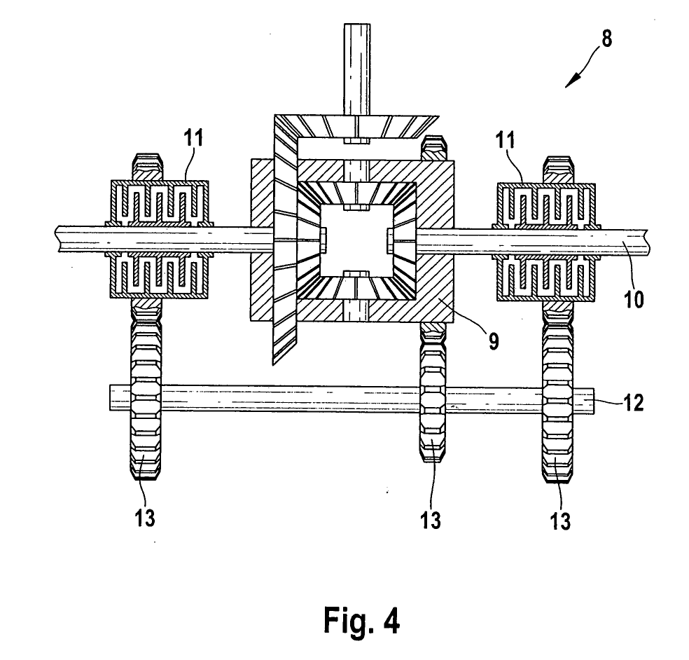

From determined input quantities, the control device therefore determines a yawing moment by means of which the yawing moment actuator is to be acted upon for supplying the defined desired lateral acceleration. As schematically illustrated in FIG. 4, during the operation, as a function of the detected quantities, the control device adjusts the yawing moment of the yawing moment actuator 8 such that, by means of a differential device 9, a differential is generated between the left-side driving torque of the axle shaft 14 assigned to the left side and the right-side driving torque of the axle shaft 10 assigned to the right side, and thereby a suitable yawing moment is generated. For this purpose, the intermediate shaft 12, for example, is coupled by way of suitable gears 13 and by way of controllable multi-plate clutches 11 with the right-side and the left-side axle shaft 10 and 14 respectively in a fitting manner. According to the definition by the control device 1, the regulating device 7 of FIG. 1 thereby controls the two multi-plate clutches 11 such that the desired differential occurs between the left-side and the right-side driving torque and thus the defined yawing moment occurs for achieving the defined total lateral acceleration.

Although the present invention was described by means of preferred embodiments, it is not limited thereto but can be modified in multiple fashions.

It is obvious to a person skilled in the art that, for determining the current coefficient of friction between the tire and the road, a method other than the above-described method can be used. For example, the coefficient of friction for the longitudinal and lateral acceleration during a braking operation of the motor vehicle is determined from the parameters of an ABS system. In addition, the rolling sounds of the tires can be recorded by means of a microphone, the frequency spectrum of the recorded rolling sounds being analyzed independently of the rotational wheel speed and, on the basis of at least parts of the determined frequency spectrum, a signal being generated which characterizes the road condition. As an alternative, the slip, that is, the intensity of the spinning between the tire and the road, can be determined from the rotational speed difference between the driving and the dead wheels or by means of an absolute speed determination above the ground. The transmitted force is calculated by the control device according to the model.

1. A method of controlling a yawing moment actuator in a motor vehicle, comprising the steps:
detecting a current steer angle of the motor vehicle,
determining a current coefficient of friction between a tire of the motor vehicle and a road,
detecting a current driving speed of the motor vehicle,
defining a desired curve as a function of the current steer angle, of the current coefficient of friction and of the current driving speed of the motor vehicle, which curves represents a connection between the current steer angle and a desired lateral acceleration at a predetermined coefficient of friction, and
adjusting a yawing moment of a yawing moment actuator such that a resulting current total lateral acceleration of the motor vehicle is controlled to a desired lateral acceleration (a_{y desired}) assigned to the current steer angle according to the defined desired curve.

2. The method according to claim 1, wherein the current steer angle is detected by a steer angle sensor and the current driving speed is detected by a rotational wheel speed sensor.

3. The method according to claim 1, wherein the current coefficient of friction is determined by using an inverse Pacejka tire model.

4. The method according to claim 3, wherein, for determining the current coefficient of friction, a current tire slip as well as a current tire force are determined, by using the Pacejka tire model, wherein the ratio between the tire slip and the current tire force being determined, analyzed, and compared with predetermined tire characteristics.

5. The method according to claim 4, wherein for determining the current lateral tire slip, a current tire slip angle of the motor vehicle is detected, is converted to an assigned tire slip speed and, by the division by a reference speed, is converted to a tire slip quantity.

6. The method according to claim 1, wherein the current coefficient of friction is a function of at least one of longitudinal acceleration, lateral acceleration and wheel load of the motor vehicle.

7. The method according claim 1, wherein current cornering curvature is determined by detecting and evaluating the current steer angle and the current driving speed of the motor vehicle.

8. The method according to claim 1, wherein first desired curves are determined and are filed as desired characteristic curves in an assigned memory device of a control device.

9. The method according to claim 1, wherein, an additional yawing moment is superimposed on the yawing moment of the yawing moment actuator to be adjusted, which yawing moment is derived from the deviation between the yaw rate desired by the driver of the motor vehicle and the current yaw rate.

10. The method according to claim 9, wherein a current yaw rate of the motor vehicle is determined by means of a yaw rate sensor device of a driving-dynamics-related system already existing in the motor vehicle, and the yaw rate desired by the driver is determined by detecting the current steer angle as well as at least one of the vehicle speed and lateral acceleration of the motor vehicle.

11. System for controlling a yawing moment actuator in a motor vehicle, said system comprising:
a steer angle detection device for detecting a current steer angle of the motor vehicle,
a coefficient-of-friction detection device for determining a current coefficient of friction between a tire of the motor vehicle and a road,
a driving speed detection device for determining a current driving speed of the motor vehicle,
a control device which defines a desired curve as a function of the current steer angle, of the current coefficient of friction and of the current driving speed of the motor vehicle and which represents the connection between the steer angle and a desired lateral acceleration when the coefficient of friction is predetermined, said control device including an adjusting device for adjusting a yawing moment of a yawing moment actuator such that a resulting current total lateral acceleration of the motor vehicle is controlled to a desired lateral acceleration (a_{y, desired}) assigned to the current steer angle according to the defined desired curve.

12. The system according to claim 11, wherein the steering angle detection device contains a steer angle sensor, and the driving speed detection device contains a rotational wheel speed sensor.

13. The system according to claim 11, wherein a memory device is provided in which an algorithm is stored by using an inverse Pacejka tire model for determining the current coefficient of friction.

14. The system according to claim 13, wherein, for determining the current coefficient of friction, the control device determines a current tire slip as well as a current tire force, by using the Pacejka tire model, determining and analyzing a ratio between the tire slip and the tire force and comparing the ratio with the previously known tire characteristics.

15. The system according to claim 14, wherein, for determining the current lateral tire slip, the control device detects a current tire slip angle of the motor vehicle, converts said current tire slip angle to the assigned tire slip speed and, by the division by a reference speed, provides a tire slip quantity.

16. The system according to claim 11, wherein, for determining the current coefficient of friction, the control device takes into account at least one of the longitudinal acceleration, the lateral acceleration and-the wheel load of the wheels of the motor vehicle.

17. The system according to claim 11, wherein the control device determines the current cornering curvature by detecting and analyzing the current steer angle and the current driving speed of the motor vehicle.

18. The system according to claim 13, wherein, desired curves are first determined first and then filed in the memory device of the control unit as desired characteristic curves.

19. The system according to claim 11, wherein the control device superimposes an additional yawing moment on a yawing moment of the yawing moment actuator to be adjusted, which additional yawing moment is derived from the deviation between a yaw rate desired by the driver of the motor vehicle and the current yaw rate.

20. The system according to claim 19, wherein a yaw rate sensor device is provided which detects the current yaw rate, the yaw rate sensor device being constructed as a yaw rate sensor device of a driving-dynamics-related system already existing in a motor vehicle.

21. The system according to claim 11, wherein, the adjusting device is constructed as a regulating device.
